(19) United States
(12) Patent Application Publication
(10) Pub. No.: US 2023/0131834 A1
(43) Pub. Date: Apr. 27, 2023

(54) TECHNIQUES FOR TRAINED MODEL BIAS ASSESSMENT

(71) Applicant: Oracle International Corporation, Redwood Shores, CA (US)

(72) Inventors: Hari Bhaskar Sankaranarayanan, Bengaluru (IN); Shahid Reza, Bengaluru (IN); Arpit Katiyar, Noida (IN)

(73) Assignee: Oracle International Corporation, Redwood Shores, CA (US)

(21) Appl. No.: 17/508,734

(22) Filed: Oct. 22, 2021

(51) Int. Cl. G06N 3/08; G06N 3/04

(52) U.S. Cl. CPC G06N 3/088; G06N 3/0454

(57) ABSTRACT

A system is disclosed that is configured to perform various bias checks on an machine learning (ML) model in order to identify one or more biases, if any, that may be inherent to the ML model. Bias evaluation results generated from performing the checks are then reported to a user, such as to a consumer of the ML model, a data scientist responsible for modeling and training the ML model, and others. The bias evaluation system performs one or more bias checks by generating synthetic datasets using attributes present in the ML model or a training dataset used to train the ML model. Prediction data is then generated by inputting the synthetically generated input data points of the synthetic datasets into the ML model. The prediction data is then processed and evaluated for biases. Results of the evaluation may be compiled into a bias evaluation report.

### BACKGROUND

Recent years have seen a rapid increase in the adoption of Artificial Intelligence (AI) and machine learning (ML) solutions in various different industries and applications. For a typical ML solution, in a training phase, an ML model is trained and validated using some particular training and validation dataset. Once the model has reached an acceptable level of accuracy in the training phase, the model is then deployed to a production environment where it is used to make predictions on real-time production data inputs. However, if the particular training dataset used to train the ML model contained biased data, the trained ML model will also make biased predictions.

Bias is a common, but non-trivial problem in ML, and is the source of many incorrect predictions made by ML models and can lead to model instability in real world scenarios. For example, ML models subject to bias may not only fail to predict correct information, but may also predict incorrect information, which the ML model represents as a proper prediction. This presents problems for services that host trained ML models for customers, and the problems are compounded when the service hosts ML models that were not trained under the supervision of the service. Bias is not a problem that can be remedied simply by increasing the size of a training dataset, and in fact, a larger biased training dataset may only reinforce unwanted biased behaviors in trained ML models. In many cases, the trained ML model is itself a “black box” element, and bias often cannot be detected simply by reviewing the composition of the trained ML model by itself.

### BRIEF SUMMARY

The present disclosure relates to evaluation of biases in trained machine learning (ML) models. A system is disclosed that is configured to perform various bias checks on an ML model in order to identify one or more biases, if any, that may be inherent to the ML model. Bias evaluation results generated from performing the checks are then reported to a user, such as to a consumer of the ML model, a data scientist responsible for modeling and training the ML model, and others. Various embodiments are described herein, including methods, systems, non-transitory computer-readable storage media storing programs, code, or instructions executable by one or more processors, and the like.

In certain embodiments, the bias evaluation functionality is offered as a cloud service by a Bias Evaluation-as-a-Service System (BEaaSS). Subscribers of such a cloud service may submit ML models to the service and receive bias evaluation reports generated by the service for the submitted ML models. The bias reports contain may information identifying the bias checks performed by the BEaaSS and their results. A recipient of a bias report, such as a data scientist, may use the information in the bias report to reduce any identified biases. For example, the data scientist may change the training dataset used to train the model to reduce a particular identified bias.

The bias evaluation system embodiments described herein provide an automated solution for detecting and evaluating various bias types inherent to a trained ML model. Based upon the attributes of the ML model, and possible the potentially biased training dataset used to train the ML model, the bias evaluation system is programmed to generate one or more synthetic datasets that may be input to the ML model. The trained ML model will make predictions based on the input synthetic dataset, and the predict may be evaluated for bias. The synthetic dataset includes a set of synthetic data points that, when input to a trained ML model with little to no inherent training bias, would not predict biased prediction data. The same set of synthetic data points, when input to a trained ML model with substantial inherent training bias, will cause substantially biased prediction data to be output. Bias may be evaluated by manually examining variations in predictions after introducing artificial bias to a dataset. If a predicted output of a ML model changes, then the model may be susceptible to bias. Bias amounts may vary based on how far the new output predictions deviate from expected predictions.

The prediction data generated from inputting the set of synthetic data points into the trained ML model are processed by an evaluator configured to detect a particular bias type within the prediction data. One or more of the evaluations may be performed for one or more specific bias types and the results may be collated in a bias report and the report may be output to an interested party. In some cases, the results and/or the report may be used to perform a number of downstream actions. The results, reports, and actions provide an bias detection and evaluation mechanism through which ML model hosts, users, and other interested parties may improve model training, testing, and implementation.

Trained ML models to be evaluated for bias according to the embodiments described herein may be received from multiple sources (e.g., a user/customer device, a repository or trained ML models, a serverless function, etc.). In some embodiments, a customer sends a trained ML model to a Bias Evaluation as a Service System (BEaaSS) to determine if the customers model generates prediction data using one or more formed of bias. In some embodiments, a model catalog system is configured to receive trained ML models for storage a model catalog. The model catalog system may communicate with the BEaaSS to determine if the received model generated predictions according to bias at an acceptable level before including the model in the model catalog.

In some embodiments, the bias evaluation system implements an attribute identifier to determine one or more attributes of a trained ML model and/or training data used to train an ML model. The attribute identifier is configured to process ML model data and/or training data used to train the ML model to determine one or more attributes of the ML model. The bias evaluation system may use the one or more determined attributes to generate synthetic data that may be input to the trained ML model to generate a prediction.

A synthetic data generator may generate synthetic data based on one or more determined attributes of a trained ML model. The one or more synthetic datasets may be input to the trained ML model to generate prediction data. The prediction data may be parsed by one or more checking entities within a BEaaSS to determine whether the prediction data corresponds to a type of bias. The one or more synthetic datasets may be generated in a certain manner to attempt to influence a trained ML model to output prediction data with bias. For example, a synthetic dataset may be generated with an unbalanced distribution of attribute values in its various synthetic data points to attempt to influence the trained ML model to generate and output prediction data that is biased. In some embodiments, synthetic datasets may be stored in a synthetic data repository after generation. When a request to evaluation a trained ML model for bias is received, and the attributes of the trained ML model share the same attributes as a synthetic dataset stored in the repository, the synthetic dataset may be selected for input to the trained ML model without requiring generation of a new synthetic dataset.

The bias evaluation system may be programmed to perform multiple bias checks in an automated manner, where each bias check is a check for bias in the prediction data output by the ML model given one or more synthetic datasets as input. Each bias check corresponds to a different bias type that may be inherent to a trained ML model. There is no limit to the types of bias that the bias evaluation system may evaluate for a trained ML model, and the evaluations may be performed in any combination or manner that is useful in evaluating the ML model.

The bias evaluation system utilizes prediction data generated by a trained ML model using synthetic dataset inputs to determine a that the trained ML model operates according to one or more biases. In some embodiments, the bias evaluation system may supplement the evaluation of the prediction data with additional evaluation{s} of training datasets used to train the ML mode. For example, a bias evaluation entity in the bias evaluation system may combine results of a bias check of the prediction data with results of a bias check of the training data to generate combined result data.

The results obtained by the bias evaluation system from performing the bias checks may then be output along with the prediction made using the ML model. These results provide additional information to a consumer of the prediction regarding the probability that predictions made by the ML model are biased, and the corresponding potential impact upon the predictions generated. The bias evaluation results generated and output by the bias evaluation system thus can provide a warning system that predictions of a model are biased, that the model itself is improperly trained, or that a training dataset used to train the ML model is deficient.

The results of one or more bias evaluations for one or more bias types may be compiled and used by the bias evaluation system to generate a bias report. The bias report may contain report information indicating the propensity of a trained ML model to generate prediction data that corresponds to one or more particular biases. The bias report may contain report information related to the one or more bias checks performed and the corresponding bias check results. The bias report may further contain an overall bias score indicating a total degree of bias detection in the prediction data and/or one or more downstream actions or recommendations that may be taken as a result of the bias evaluation.

The set of one or more bias check results may also be used to determine one or more downstream actions to perform in response to the generation of the one or more bias check results. For example, one downstream action may be generating and sending, based on the one or more bias check results, a message to a data scientist of an enterprise that a trained ML model has a propensity to generate biased prediction data and/or that the trained ML model was trained using a deficient/biased training dataset. Another downstream action may be preventing further dissemination of the trained ML model, or prevention of inclusion of the trained ML model in a model catalog. Yet another downstream action may be sending the prediction data and the bias report to a client/service that supplied the trained ML model originally.

The bias evaluation system may be offered as a cloud service by a cloud services provider in some embodiments. The services are made available to a customer or subscriber who subscribes to this and other services provided by the cloud services provider.

In certain embodiments, techniques are disclosed wherein a bias evaluator as a service system performs processing comprising for a trained model to be evaluated, determining, by a computing system, a set of model attributes for the trained model; generating, by the computing system and based upon the set of model attributes, a first synthetic dataset to be used for a first bias check to be performed for the trained model, the first bias check configured to evaluate the trained model with respect to a first bias type, the first synthetic dataset comprising a plurality of data points; generating, using the trained model, first prediction data for the first synthetic dataset, the first prediction data comprising a first plurality of predicted values generated by the trained model for the plurality of data points in the first synthetic dataset; generating, by the computing system, a first bias result for the first bias type based upon the first prediction data; and generating, by the computing system, a bias evaluation report for the trained model, wherein the bias evaluation report comprises information indicative of the first bias result.

In certain embodiments, the first bias result comprises one or more bias values generated based on the first prediction data. In some further embodiments, the bias evaluation report comprises the first bias result and the one or more bias values, and the method further comprising outputting the bias evaluation report.. In other further embodiments, the method further comprises comparing at least a bias value of the one or more bias values to a bias to a bias threshold; and determining, based on the comparison, whether to accept or reject the trained model from inclusion in a group of trained models.

In certain embodiments, the processing further comprises generating, by the computing system and based upon the set of model attributes, a second synthetic dataset to be used for a second bias check to be performed for the trained model, the second bias check configured to evaluate the trained model with respect to a second bias type, the second synthetic dataset comprising a plurality of data points; generating, using the trained model, a second set of predictions for the second synthetic dataset; and generating, by the computing system, a second bias result for the first bias type based upon the first prediction data. In some further embodiments, the method further comprises generating, by the computing system, a bias score based on the first bias result and the second bias result; and determining, based on the generated bias score, whether to accept or reject the trained model from inclusion in a group of trained models.

In certain embodiments, determining the set of model attributes comprises processing the trained model to determine at least one model attribute in the set of model attributes. In some embodiments, determining the set of model attributes comprises determining at least one model attribute in the set of model attributes based upon analysis of training data used for training and generating the trained model.

In certain embodiments, the processing further comprises determining training data used for training and generating the trained model; and generating, by the computing system, a second bias result for the first bias type based on the training data, wherein generating the first bias result is further based on the generated second bias result. In some embodiments, generating the first synthetic dataset comprises generating, by the computing system and based on the set of model attributes for the trained model and using a generative neural network machine learning model, the first synthetic dataset.

In certain embodiments, a system, such as a bias evaluator as a service system, comprises a processor and memory including instructions that, when executed by the processor, cause the device to perform the processing described herein. In another example embodiment, a non-transitory computer-readable medium stores a plurality of instructions executable by one or more processors to cause the one or more processors to perform the processing described herein.

The foregoing, together with other features and aspects will become more apparent upon referring to the following specification, claims, and accompanying drawings.

### BRIEF DESCRIPTION OF THE DRAWINGS

FIG. 1 is a simplified diagram of a distributed environment incorporating a bias evaluator as a service system, according to various embodiments.

FIG. 2 depicts a simplified diagram of a bias checker component of a bias evaluator as a service system, according to various embodiments.

FIG. 3 depicts a simplified diagram of an attribute identifier component of a bias evaluator as a service system, according to various embodiments.

FIG. 4 depicts a simplified flow diagram illustrating an example process for generating a bias evaluation result for a trained machine learning model using a bias evaluator as a service system, according to various embodiments.

FIG. 5 depicts an example bias evaluation report generated by a bias evaluation as a service system, according to various embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain aspects. However, it will be apparent that various aspects may be practiced without these specific details. The figures and description are not intended to be restrictive. The word “exemplary” is used herein to mean “serving as an example, instance, or illustration.” Any aspect or design described herein as “exemplary” is not necessarily to be construed as preferred or advantageous over other aspects or designs.

The present disclosure relates to evaluation of biases in trained machine learning (ML) models. A system is disclosed that is configured to perform various bias checks on an ML model in order to identify one or more biases, if any, that may be inherent to the ML model. Bias evaluation results generated from performing the checks are then reported to a user, such as to a consumer of the ML model, a data scientist responsible for modeling and training the ML model, and others. Various embodiments are described herein, including methods, systems, non-transitory computer-readable storage media storing programs, code, or instructions executable by one or more processors, and the like.

In certain embodiments, the bias evaluation functionality is offered as a cloud service by a Bias Evaluation-as-a-Service System (BEaaSS). Subscribers of such a cloud service may submit ML models to the service and receive bias evaluation reports generated by the service for the submitted ML models. The bias reports contain may information identifying the bias checks performed by the BEaaSS and their results. A recipient of a bias report, such as a data scientist, may use the information in the bias report to reduce any identified biases. For example, the data scientist may change the training dataset used to train the model to reduce a particular identified bias.

There are various reasons why bias may creep into a trained ML model. Typically, this happens when a dataset that is used to train a model contains data points that are heavily represented or weighed towards a particular attribute. Such a weighed or skewed dataset may result in a trained model being generated that does not properly represent the real world environment or use cases where the trained model is to be used to make predictions. For example, a model that is trained to select resumes of potential candidates may be biased towards selecting resumes of men or women if the training dataset used to train the mode primarily included resumes of men with very few data points corresponding to resumes of women. A trained ML can be biased due to different types of biases such as sample bias, exclusion bias, measurement bias, label/recall bias, observer bias, association bias, gender bias, religion bias, race bias, and others in the training dataset. High levels of bias can cause the model to miss the relevant relations between features or attributes of the data and outputs predicted by the model.

If a particular training dataset used to train a ML model contained biased data, the trained ML model will also likely make biased predictions. Bias is a common, but non-trivial problem in ML, and is the source of many incorrect predictions made by ML models. For example, ML models subject to bias may not only fail to predict correct information, but may also predict incorrect information, which the ML model represents as a proper prediction. For example, a trained ML model that generates prediction data in a biased manner may be more likely to generate incorrect predictions when a certain input data point is provided to the machine learning model. The trained ML model is “biased” when the prediction data generated by the ML model contains undesirable values or results that would not appear in the same proportion if generated by a correctly trained ML model. Bias will occur when a ML model has been trained in a particular way such that the model has a tendency to output biased prediction data. Because training dataset are often not homogenous (i.e., the attributes of data in the datasets used to train the model are often incomplete or biased), the trained ML model is often biased due to training on these datasets . For example, a “biased” ML model may tend to predict incorrect values, or values outside of an expected range based given an input data point. A biased model will also change output predictions in a manner heavily influenced by input data with high levels of bias in the input dataset. Bias may come in many types and formats, including, for example, selection bias, stereotyping bias, reporting bias, in-group bias, anecdotal fallacies, etc.

Biased ML models generate undesirable prediction data more frequently than properly trained ML model. Worse, the model may be biased toward certain predictions for one attribute/type, but not another attribute/type. Thus the model may appear to predict data with high accuracy for some input data points, but produces biased prediction data for other, more specific input data point. This presents problems for services that host trained ML models for customers, and the problems are compounded when the service hosts ML models that were not trained under the supervision of the service provider. For example, for a service provider hosting an ML model for a customer where the service provider is not involved in and has no control over the training of the model, the ML model is like a “black box” for that service provider who may not have any insight into the potential biases of the ML model. Bias is not a problem that can be remedied simply by increasing the size of a training dataset, and in fact, a larger biased training dataset may only reinforce unwanted biased behaviors in trained ML models. The “black box” nature of ML models means that bias often cannot be detected simply by reviewing the composition of the trained ML model by itself.

The bias evaluation system embodiments described herein provide an automated solution for detecting and evaluating various bias types that may be inherent to a trained ML model. In certain embodiments, for an ML model to be evaluated, the inputs provided to the bias evaluation system may be the model to be evaluated, and if available, the training dataset used to train the ML model. The bias evaluation system is programmed to determine the attributes of the ML model to be evaluated. If a training dataset is provided as input, the bias evaluation system may analyze the training dataset to determine attributes of the inputs to the model. Based upon the identified attributes, the bias evaluation system uses synthetic data generation techniques to generate one or more synthetic datasets, each synthetic dataset geared towards checking a particular bias and containing multiple data points synthetically generated for checking that particular bias.

The bias evaluation system them performs various bias checks using the synthetic datasets and generates evaluation results. For a particular bias to be evaluated, the bias evaluation system inputs the synthetic dataset generated for that bias to the ML model being evaluated and determines a predicted value generated by the ML for each of the input data points from the synthetic dataset. The predicted values generated by the ML model for data points in a synthetic dataset for a particular bias check are collectively referred to as the prediction data generated by the ML model for the synthetic dataset for the particular bias check. The bias evaluation system then analyzes the prediction data to generate a bias evaluation result for that particular bias check. In certain embodiments, the bias evaluation result indicates a degree of bias exhibited by the ML model for the particular bias being evaluated. The degree may be indicated by a metric, a score, a visualization (e.g., a graph), and the like.

An example of such an ML model is a trained neural network (NN), which is composed of multiple nodes organized into layers, with each layer containing one or more nodes. The layers include an input layer to which inputs are provided and an output layer that outputs the predicted value for the input provided as input to the input layer. Zero or more intermediate layers may be sandwiched between the input and output layers, with the output of one layer provided as input to the next layer. For such a neural network model, for a synthetic data point provided as input to the input layer of the neural network, the output layer of the neural network will output a predicted value, which represents the value predicted by the neural network for the input.

Additionally, as part of generating the predicted value, each of the intermediate layers and nodes in the layers may generate intermediate values that are passed to the next layer until the output layer is reached and the output layer outputs the predicted value. In such embodiments, the prediction data generated by the model for a synthetic dataset includes the final values predicted by the output layer of the neural network. This prediction data is then analyzed by the bias evaluation system to generate a bias result for the particular bias check. As described herein, the final result of the ML model processing an input is referred to as “prediction data.”

For example, once the prediction data is generated, the prediction data is processed by an evaluator configured to detect a particular bias type within the prediction data. The evaluation may use the prediction data for a synthetic dataset to evaluate the ML model for a particular bias, and may also use other aspects of the bias detection process, such as the one or more attributes, the input synthetic data points, etc. For example, a bias evaluator may compare prediction data output by the trained ML model with one or more synthetic input values to determine an expected distribution of prediction values and an actual distribution of prediction values. In some embodiments, the evaluation may be based on statistical determinations and functions as applied to a set of prediction data.

One or more of the evaluations may be performed for one or more specific bias types and the results may be collated in a bias report. The report may be output to an interested party. For example, for a trained ML model that is evaluated, results of various bias checks performed for that models may be compiled or aggregated into a comprehensive report reviewable by a submitting entity that submitted the trained ML model for bias evaluation. The report may include information indicative of the various bias checks that are performed by the bias evaluation system and their corresponding evaluation results, an overall bias evaluation result, a number of suggested downstream actions, for example, sending the report to an entity, rejecting the model from a model catalog, retraining the ML model, etc. In some embodiments, a user or entity receiving a bias evaluation report may select one or more downstream actions to perform based on the bias report generated. For example, a service implementing a report generation may also contain one or more subsystem by which a user may indicate that the one or more subsystems should act. For example, a retraining subsystem for retraining a biased model may be suggested by the bias report and a user may indicate to the subsystem to retrain the biased model in response to receiving the report, etc.

In certain embodiments, the degrees of a particular bias may be represented using a metric associated with the bias result. Various different metrics may be used such as scores, graphs, etc. representing the degree of bias. For example, the results of the various bias checks performed may be compiled in a number of visual graphs and score metrics recognizable and understandable by humans and/or machines.

In some embodiments, an overall bias score may be presented in a bias evaluation report. The overall bias evaluation may be a compiled bias evaluation score that is based on a number of sub-scores corresponding to a number of specific biases evaluated. For example an overall bias evaluation score may be a comprehensive score, such as an average score, or a plurality of sub-scores of individual bias evaluations.

In some cases, the results and/or the report may be used to perform a number of downstream actions. Downstream actions may include, for example, corrective actions to correct a bias or other responsive actions that response to the results of the bias evaluation. A corrective action may be an action which corrects biased behaviors in the model in response to detection of bias in the results. For example, retraining the ML model with an unbiased training dataset may be a downstream action that will correction bias behaviors in ML models. The corrective actions may be initiated by a user in response to receiving the bias report. Responsive action may be actions for occur based on the state of the model following evaluation. For example, determining to reject a model from inclusion in a model catalog and rejection of the model from the model catalog may occur in response to determining a ML model operates with an impermissible level of bias.

The results, reports, and actions provide a bias detection and evaluation mechanism through which ML model hosts, users, and other interested parties may improve model training, testing, and implementation. For example, in some embodiments, a model catalog that provides a repository for ML models submitted by user, may use the bias evaluation services of BEaaS. The model catalog may submit a bias evaluation request to the BEaaSS where the request includes the ML model to be evaluated, and may also include the training data used to train the model. After performing the bias evaluation, the BEaaSS may generate a bias evaluation report and send the report to the model catalog as a response to the request sent by the model catalog. The model catalog may then take one or more actions based upon the bias evaluation report. In certain implementations, if the report indicates that the ML model failed the bias evaluation, then the model catalog may reject the model from being added to the model catalog. The model catalog may allow the ML model to be added to the model catalog only upon receiving a passed bias evaluation result from BEaaS.

Techniques for facilitating a BEaaSS will provide number technical advantages that improve the function and implementation of trained ML models. For example, the BEaaSS described here will provide a novel automated bias evaluation system and service not previously available. For example, model evaluation is largely done manually and on a per-bias basis. Implementation of a BEaaSS as described herein will allow for automated and comprehensive bias evaluation for a trained ML model. The BEaaSS will facilitate a techniques for automatically intaking, in response to a request, a trained ML model, performing comprehensive bias evaluation, and outputting results. This will provide a centralized system for automated model improvement for a variety of bias tests.

The BEaaSS described also provides technical advantage by abstracting actions away from clients and owners of the trained ML model. Because of the automated nature of the BEaaSS, a model owner/model catalog does not need to actively participate in model evaluation and bias assessment. The checks, including the generation of synthetic datasets for performing the checks, are automatically performed by the BEaaSS without requiring input from a client beyond a request to evaluated the model. This improves user resource utilization while also centralizing the system for evaluating the ML model. A user does not need to know what checks are performed, or the central mechanics of the checks. Instead a user need only generate a request for model evaluation and await an automatically generated report in response to the request.

The BEaaSS describe will also provide flexible checking functions that may be updated as required as a centralized service. For example, as new bias checks evolve, improve, and otherwise modified, the centralize nature of the BEaaSS will allow the checks to be updated in a single location rather than requiring users to manually download and proliferate a newest set of bias checks. This more easily integrates the BEaaSS into a user's workflow, and also preserves user resources. This also ensures that secure applications like a model catalog is always updated with the most modern checks to comprehensively diagnose new and problematic biases in near real time.

### EXAMPLE SYSTEMS AND EMBODIMENTS

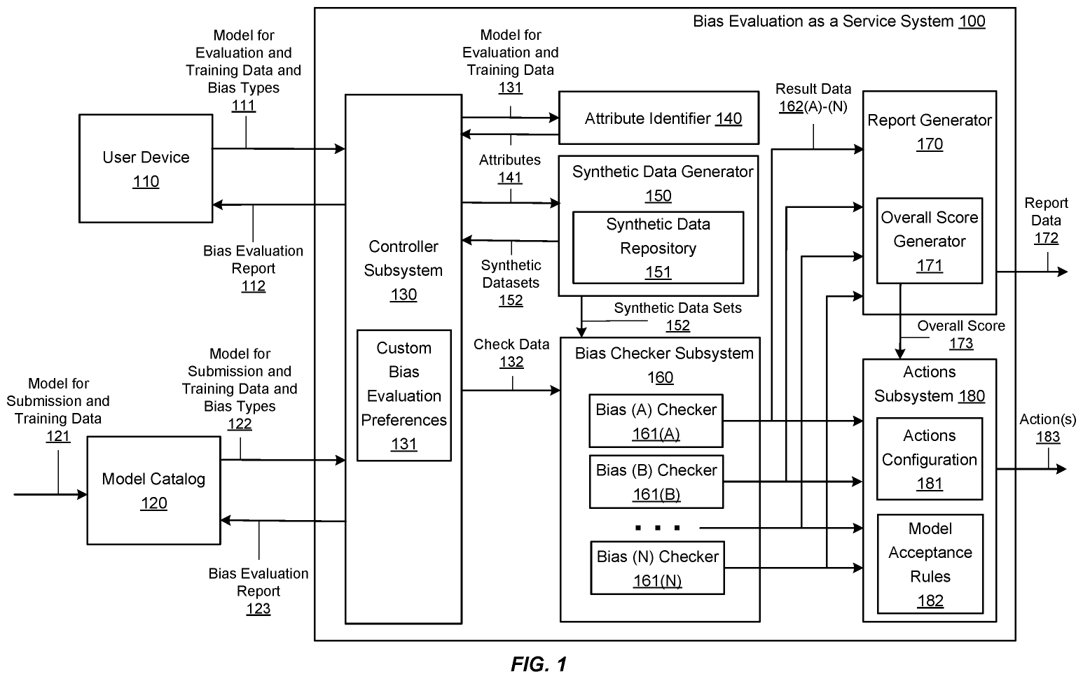

FIG. 1 is a simplified diagram of a distributed environment incorporating a bias evaluator as a service system, according to various embodiments. As shown in FIG. 1, the distributed environment comprises multiple systems and subsystems. The distributed environment comprises bias evaluation as a service system BEaaSS 100. BEaaSS 100 may be a service implemented on a computing device, such as a server system. BEaaSS may be a service configured to facilitate the embodiments described herein, namely the evaluation of trained ML models for one or more bias types. For example, BEaaSS may be a service configured to receive trained ML models from separate external systems, evaluate the trained ML model for bias, and return a bias report and/or perform a downstream action based on the evaluation.

Controller subsystem 130 is a subsystem of BEaaSS 100. Controller subsystem 130 may be a subsystem configured to facilitate operation of BEaaSS 100 and its communication with external systems. For example, controller subsystem 130 may be a central subsystem with access to various other subsystems of BEaaSS 100. The controller subsystem 130 may then facilitate the transfer of data within BEaaSS 100 and invoke the various other subsystems to perform the embodiments described herein. Controller subsystem 130 may communicate with systems external to BEaaSS 100 to intake and output data as part of the embodiments described herein. For example, BEaaSS 100 may be implemented as part of a model evaluation service offered to customers by a service provider. Controller subsystem 130 may be configured to communicate with customer/user devices to receive trained ML models for evaluation as part of the service.

User device 110 may be a computing device or system communicatively coupled to BEaaSS 100, for example through the controller subsystem 130. User device 110 may be a computing device utilized by a customer of a service implementing BEaaSS 100 to send a trained ML model for evaluation. For example, a service provider may offer a service implementing BEaaSS 100 through which a customer/user may submit a trained ML model owned by the customer/user for evaluation. The customer may receive, in response to sending the trained ML model to BEaaSS 100, a response including information and/or actions relating to the trained ML model.

User device 110 may send model for evaluation and training data and bias types 111 to controller subsystem 130. The model sent to controller subsystem 130 is the trained ML model that will be evaluated for bias. In some embodiments, the user device may also send training data to controller subsystem 130. Training data may include at least a training dataset used to train the trained ML model also sent to controller subsystem. In some embodiments, bias types may also be sent to controller subsystem 130. Bias types may indicate one or more bias checks that the customer utilizing the user device 110 may be requesting as part of a bias evaluation for the trained ML model. In some embodiments where the bias types are not sent, all available bias checks are performed on the trained ML model by default. In some embodiments where the bias types are not sent, a subsystem of BEaaSS 100, such as an attribute identifier, may process the trained ML model and possibly the training dataset to determine one or more bias types possible or likely inherent to the trained ML model.

Once it is complete, a bias evaluation report 112 may be sent from controller subsystem 130 to user device 110 as a response to the sending of the model for evaluation and training data and bias types 111. More information about bias evaluation reports will be discussed below.

In some embodiments, BEaaSS 100 is communicatively coupled to a model catalog 120. A model catalog 120 may be a model service that hosts a number of trained ML models that may be utilized by customers of the model service. For example, a model service may allow source customer/user's to upload their own trained ML models for inclusion in the model service. Other customers/users may then utilize the source customer/user's trained ML model. As discussed above, for this reason, it is very important for the model service provider to only host trained ML models with little to no inherent bias to maintain an optimal model service.

In some embodiments, the model catalog 120 can also include a domain ontology store for storing a plurality of models, where each model is grouped into a domain. Each domain specifies an attribute or industry common to a number of models. A model recommendation engine of the model catalog 120 can compare customer-supplied data to a plurality of models in a domain ontology store to identify one or more recommended models for a customer's use. For instance, the model recommendation engine can identify a number of similar terms between parsed data and terms associated with each model. In some instances, the model recommendation engine can generate a confidence metric for each model. The confidence metric can include a value (a percentage from a range of values) indicative of an estimated likelihood that the model is relevant to a set of customer supplied data. The confidence value can be based on a number of common terms between each model and the parsed data from the dataset. The model recommendation engine can identify one or more recommended models specific to the customer supplied data. For example, a listing of recommended models and a description of each recommended model can be provided to a client device for selection of a recommended model. The model catalog 120 can generate the domain ontology store and can continuously add new models to the domain ontology store. [0001] A feedback and learning engine can obtain feedback data from the recommendation of a model and subsequent selection/rejection of the model for a specific set of customer-supplied data. As described above, it is important that models supplied to customers generate prediction data with little to no bias. Therefore, maintaining the model catalog 120 with only models containing an acceptable level of bias is a critical goal of a model catalog service provider.

Model catalog 120 may receive model for submission and training data 121. The model for submission and training data 121 may be received from, for example, a user of the model catalog that is seeking to submit the model for submission for inclusion in the model catalog. The training data may also be supplied along with the model for submission. Model catalog 120 is communicatively coupled to BEaaSS 100 through controller subsystem 130. Model catalog 120 may transmit a request to BEaaSS 100 to perform evaluation for the model for submission prior to accepting the model for submission as part of the model catalog 120.

Model catalog 120 may send model for submission and training data and bias types 122 to controller subsystem 130. The model for submission and training data are the same data received as part of the submission described above. Additionally, the model catalog may generate and send, to BEaaSS 100, bias types corresponding to bias checks that the model catalog requires models for submission to pass before the model for submission is accepted into the model catalog. The bias types generated by model catalog 120 may correspond to some bias checks that are critical to a particular model catalog and may exclude others that are not critical. For example, a model catalog configured to host models for predicting salaries of human employees may be required to have less than a threshold level of evaluated gender, racial, and language biases before a model may be included therein. Other biases, such as profanity, social-media presence, etc. may not be important factors for models in the model catalog and thus will not be included in the bias types generated and sent from model catalog 120.

Once it is complete, a bias evaluation report 123 may be sent from controller subsystem 130 to user device 110. The bias evaluation report 123 may be similar to the bias evaluation report 112 that may be sent to the user device 110 described above. In addition, bias evaluation report 123 may contain one or more sets of data corresponding to recommended decisions that the model catalog 120 may take with regard to a submitted model. For example, bias evaluation report may contain an recommendation that model catalog 120 accept or reject the model for submission for inclusion in the model catalog 120.

Custom bias evaluation preferences 131 is one or more sets of configurations of bias preferences stored in controller subsystem 130. In embodiments where bias types corresponding to bias checks to be performed are not sent to BEaaSS 100, custom bias evaluation preferences 131 may contain data relating to one or more preferred bias types for evaluation a trained ML model. For example, a user of a user device 110 may be associated with a custom bias evaluation preference listing one or more bias types that the user typically uses in trained model bias evaluation. In other examples, customer bias evaluation preferences 131 stores information regarding optimal bias types associated with a model catalog 120. As discussed above, the bias types may determine one or more bias checks to perform for a given trained ML model. Once the trained ML model and the bias types are determined/received, the BEaaSS 100 may commence with evaluating the trained ML model for biases.

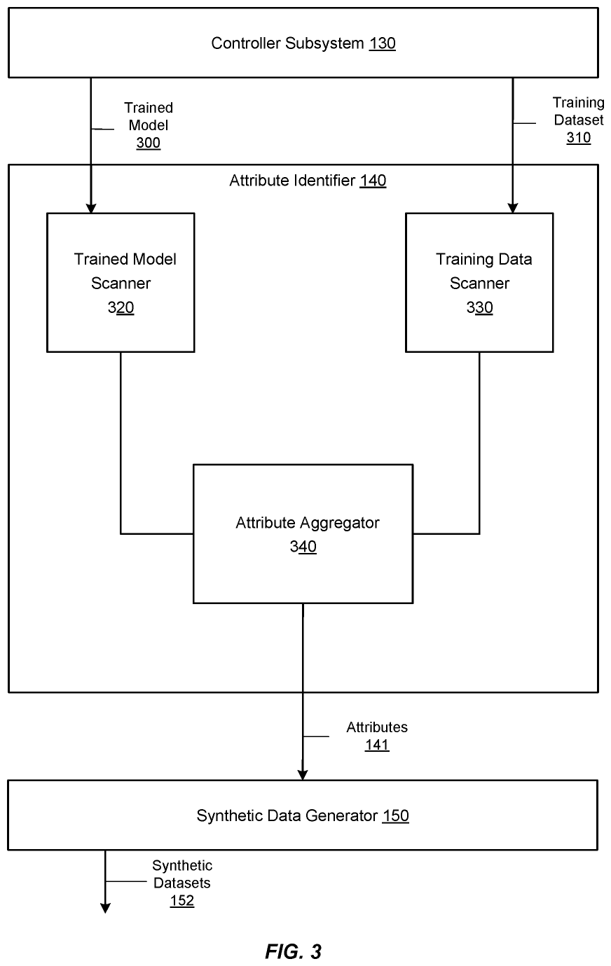

BEaaSS 100 may first cause determination of one or more attributes for generating a synthetic dataset that may be input to the trained ML model. Controller subsystem 130 sends model for evaluation and training data 131 to attribute identifier 140. Attribute identifier 140 may process the model for evaluation and training data 131 to determine one or more attributes for generating a synthetic dataset. Functions of attribute identifier 140 are discussed below with regard to FIG. 3. Once the attributes are determined, attribute identifier 140 sends attributes 141 to controller subsystem 130. In some embodiments, attribute identifier 140 may send the one or more attributes 141 directly to a synthetic data generator, such as synthetic data generator 150.

Once the one or more attributes for generating synthetic data are determined, BEaaSS 100 will cause generation of synthetic data that may be input to the trained ML model to cause generation and output of prediction data. Controller subsystem may forward attributes 141 received from attribute identifier 140 to synthetic data generator 150. Synthetic data generator 150 may be a subsystem BEaaSS 100 configured to generate one or more synthetic datasets that may be input to a trained ML model to cause the trained ML model to generate and output prediction data. The synthetic may be generated in a manner such that when the synthetic datasets are input to one or more trained ML models, the one or more trained ML models are more likely to generate prediction data which corresponds to biased predictions. More specifically, synthetic input data points in the synthetic dataset are generated in a manner such that the input data points contain values that, when input to the trained ML model, will produce prediction data that demonstrates potential biases inherent to the trained ML model more clearly.

The synthetic data generator 150 may employ one or more ML techniques for generating the synthetic datasets. These techniques may include one or more machine-learning (ML) techniques, rules-based techniques, and others. In certain implementations, one or more machine-learning-based techniques may be used. For example, Generative Adversarial Networks (GANs) may be used to generate the synthetic data in the synthetic datasets, where the generated synthetic data closely resembles the original or real data. An example of a GAN architecture has been described in “Ian J. Goodfellow et al., Generative Adversarial Nets, NIPS'14: Proceedings of the 27th International Conference on Neural Information Processing Systems, Volume 2, December 2014, pp. 2672-2680.” The entire contents of the Goodfellow et al. publication are incorporated herein by reference for all purposes. In some embodiments, generative models and artificial neural networks (ANN) such as natural language generation models (NLG) and hidden Morkov Models (HMM).

A GAN is capable of generating synthetic data based upon real data that is provided as input to the GAN. The synthetic data generated by a GAN mimics the real data in terms of essential parameters, univariate and multivariate distribution, cross-relations between the variables, and so on. During training, a GAN learns the true data distribution of the input training dataset with a view to generating new data points from this distribution with some variations and not just reproducing the old data the model has been trained on. In certain use cases, the synthetic data generated by a GAN can be used to augment the real data to produce synthetic datasets. Because GAN may generate data from a distribution of training data on which the GAN was trained, one or more GANs may be trained on well know-biases to generate datasets with those biases as well. In this manner, one or more GANs can be modified to output biased datasets in a controlled manner for use in testing a model for bias. Deep learning models can also alter existing datasets to generate modified synthetic datasets containing a specified bias as part of the bias detection techniques described herein.

A typical GAN architecture consists of two adversarial models generally implemented as neural networks that compete with each other. These adversarial models include a generator neural network (generator) and a discriminator neural network (discriminator). The generator is trained to generate new synthetic data based upon real data provided as input to the generator. The discriminator is a type of classifier that is trained to differentiate between real data or synthetic data by estimating a probability that a sample generated by the generator is real data or generated data. During the training of a GAN, the generator and discriminator play a continuous adversarial game, as a result of which, as the training progresses, the generator learns to produce more realistic data samples based upon the input training data, and the discriminator learns to get better at distinguishing the generated synthetic data from the real data. This adversarial cooperation between the two networks is responsible for the success of the GAN, where they both learn at the expense of one another and attain an equilibrium over time.

A trained GAN can then be used to generate synthetic data for data provided as input to the GAN. A GAN, for example, may be used to generate the various synthetic datasets described in the disclosure. There are different GAN architectures for generating different types of synthetic data, including architectures for generating synthetic tabular data. The GAN may also be used to produce heterogeneity of synthetic datasets generated. For example, in an attempt to “trick” a potentially biased ML model, the GAN may generate synthetic datasets for bias testing that are heterogeneous (i.e., the synthetic datasets vary in the structure of data attribute, contain missing values, missing data types, etc.). This allows for introduction of data attributes or data ranges that may not have been present in the training datasets used to train the ML model.

Other machine-learning-based techniques, other than GANs, may also be used to generate the synthetic datasets described in this disclosure. These techniques may include the use of neural networks (e.g., convolutional neural networks (CNNs)), Variational Autoencoders (VAEs), decision trees, random forest techniques, linear regression, other deep learning techniques, and others.

Additionally, non-machine-learning based techniques may also be used in addition to or instead of machine-learning-based techniques to generate synthetic datasets. These include, for example, various sampling and best-fit techniques, Monte Carlo techniques, and others.

Synthetic data repository 151 may be a repository within synthetic data generator 150 configured to store generated synthetic datasets. Once synthetic dataset are generated by synthetic data generator 150, the synthetic datasets may be forwarded to another subsystem of BEaaSS 100 and/or stored in synthetic data repository 151. Storing the generated synthetic datasets in synthetic data repository 151 may comprise storing synthetic datasets according to a particular bias type associated with the generated synthetic datasets. For example, synthetic data generator 150 may receive attributes 141 and a listing of bias types including “Bias A” that will be performed using the synthetic data generated. Synthetic data generator 150 may generate a synthetic dataset using the one or more attributes for used in evaluations a model for Bias A. The synthetic dataset for Bias A may then be stored in synthetic data repository 151.

In some embodiments, synthetic datasets may be retrieved from synthetic data repository 151 in lieu of, or in addition to, the generation of new synthetic data. For example, in response to receiving one or more attributes 141 and a listing of bias types, synthetic data generator may search synthetic data repository 151 for previously generated synthetic datasets corresponding to the particular bias type and the one or more attributes. If a stored synthetic dataset is found, the stored synthetic dataset may be retrieved and sent to another subsystem of BEaaSS 100. In some embodiments, techniques such as k-fold validations are used to improve test quality of synthetic dataset generation.

Synthetic data generator 150 may send synthetic datasets 152 to controller subsystem 130 and/or bias checker subsystem 160. In some embodiments, synthetic data generator 150 sends the generated synthetic datasets 152 directly to a bias checker subsystem, such as bias checker subsystem 160. The synthetic datasets 152 may be used responsively by bias checker subsystem to being performance of evaluations of the trained ML model. In some embodiments, synthetic data generator 150 sends the generated synthetic datasets 152 to controller subsystem 130. Controller subsystem 130 may then responsively group the generated synthetic datasets into a package of data that may be used to perform an evaluation of a trained ML model. For example, the controller subsystem 130 may group the received synthetic datasets 152 with the trained ML model for evaluation, the training data used to train the trained ML model, and bias types data specifying one or more bias checks to perform. The data may be grouped as a set of check data 132 that is sent to the bias checker subsystem 160 to perform one or more bias checks for the trained ML model. The check data 132 may be a comprehensive set of data including one or more of the synthetic datasets 152, an indication of the one or more bias checks to perform, the originating entity of the request to perform the bias evaluation, etc.

Bias checker 160 may be a subsystem of BEaaSS 100 that utilizes one or more bias checkers 161(A)-(N) to perform bias evaluations for various bias types. Bias checker 160 may be configured to receive check data 132 from controller subsystem 130 and/or synthetic data sets 152 from synthetic data generator 150 to begin performance of bias evaluations for a trained ML model. In various embodiments, bias checker subsystem 160 may receive a listing of bias types and parse the listing to determine one or more bias checks to be performed by one or more bias checkers 161. The bias checker subsystem 160 may forward data, such as the trained ML model to be evaluated, the synthetic data, and possibly the training datasets to the one or more bias checkers 161 to being the evaluation of the trained ML model.

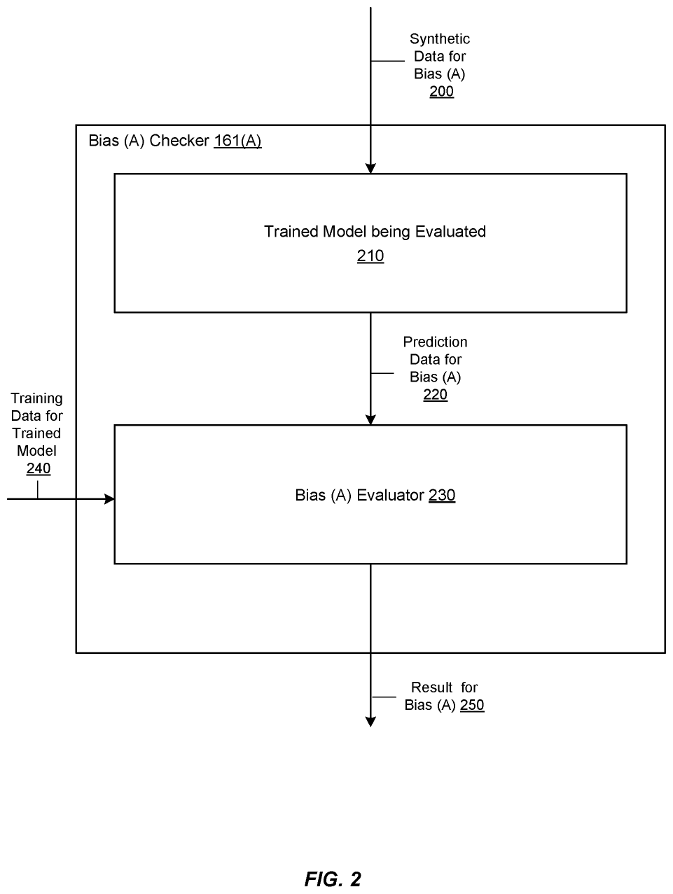

Bias checkers 161(A)-(N) are configured to received data including the synthetic datasets and the trained ML model for evaluation and responsively generate and output result data 162(A)-(N). The result data 162(A)-(N) corresponds to results of bias evaluations performed on the trained ML model. More information regarding to function of bias checkers 161 is described below, with reference to FIG. 2.

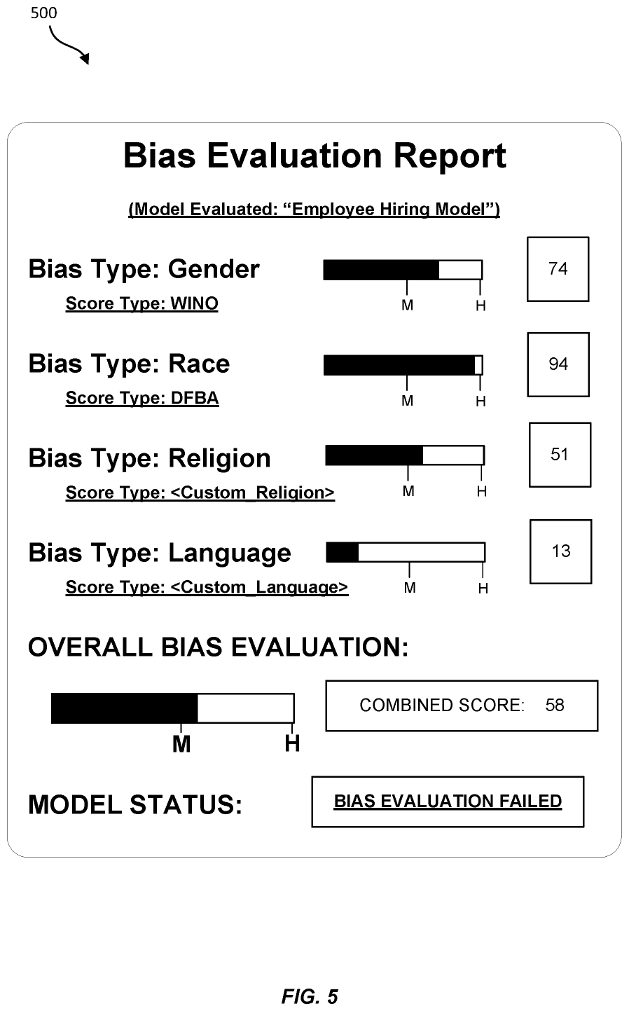

The result data 162(A)-(N) generated by the bias checkers 161(A)-(N) is sent to one or more subsystems of BEaaSS 100. For example, result data 162(A)-(N) is sent to a report generator 170. Report generator 170 may be a subsystem of BEaaSS 100 configured to generate one or more reports including the result data 162(A)-(N) or other information relating to the results of the bias evaluation. In some embodiments, the report information in compiled in a human and/or computer readable format for processing and determining aspects of the bias evaluation. In certain embodiments, overall score generator 171 is a subsystem of report generator 170 that is configured to derived a single score for the bias evaluation process. For example, overall score generator 171 may utilize result data 162(A)-(N) to generate an overall score for bias regarding the trained ML model evaluated. The reports generated by report generator 170 and in some embodiments the overall score generated by overall score generator 171 are sent to a separate entity at report data 172. For example, report data 172 may be returned to a user device 110 along with the bias evaluation report 112 or the report data 172 may be returned to a model catalog 120 as part of the bias evaluation report 123. More details regarding a bias evaluation report are described below, with reference to FIG. 5.

Result data 162(A)-(N) may also be sent to actions subsystem 180. Actions subsystem 180 may be a subsystem of BEaaSS 100 configured to intake result data 162(A)-(N) and responsively cause performance of one or more actions or generate recommendations to perform one or more actions. Actions configuration 181 may be a set of configuration data specifying how actions are performed based on the result data 162(A)-(N). Actions configuration 181 may specify certain configurations for which actions will be taken if bias results or a bias score meets a metric threshold for action. Actions subsystem 180 may receive an overall score 173 from overall score generator 171. The overall score 173 may be parsed and compared to an action threshold to determine if an action should be taken based on the overall score 173. For example, actions configuration 181 may specify that actions subsystem 180 should send a report to a data scientist if the overall score 173 surpasses a pre-set bias threshold for reporting. In some configurations, model acceptance rules 182 are a set of rules within actions subsystem 180. Model acceptance rules 182 specifically describing criteria for accepting or rejecting a model from a model catalog 120. For example, model acceptance rules may specify that actions subsystem 180 shall send a recommendation to model catalog 120 along with bias evaluation report 123 to accept a trained ML model if the bias detected for the model predictions is less than an acceptable bias threshold. Actions subsystem 180 may cause performance of action(s) 183 in this manner.

Further details related to processing performed by BEaaSS for generation of the bias evaluation report to be served with the prediction data are described below with reference to FIGS. 2, 3, 4, and 5.

FIG. 2 depicts a simplified diagram of a bias checker component of a bias evaluator as a service system, according to various embodiments. As depicted in FIG. 2, the bias checker depicted comprises several components through which data is generated. Specifically, FIG. 2 depicts a bias (A) checker 161(A) for intake of synthetic data and outputting bias evaluation results.

As part of bias checker 160, Synthetic data for bias (A) 200 is received by trained model being evaluated 210. Model being evaluated 210 is the trained ML model for which an evaluation is being sought. In some embodiments, synthetic data for bias (A) is a set of synthetic data generated specifically for performing a bias evaluation for “Bias A” on the particular trained model being evaluated 210, and is generated by the synthetic data generator 150 for that specific purpose. Trained model being evaluated 210 is configured to take the synthetic data for bias (A) 200 as input to cause generation and output of prediction data for bias (A) 220. The prediction data for bias (A) 220 may be prediction data including one or more predictions values generated by the trained model being evaluated 210 using a NN ML model.

In an example embodiment, Bias A is a gender bias and a bias test for Bias A is a bias test for gender bias in a trained ML model. In the same example embodiment, the trained model being evaluated 210 is a model for predicting a salary of an employee given an input data point including attribute values such as an employee's name, gender, occupation, etc. In the same example embodiment, the synthetic data for bias (A) 200 is a synthetic dataset including several synthetic input data points with attribute values corresponding to a theoretical employee's name, gender, occupation, etc. Thus, when synthetic data for bias (A) 200 is input to trained model being evaluated 210, the trained model will output prediction data for bias (A), corresponding to several salary predictions for each of the synthetic input data points. In the same example embodiment, the synthetic data for bias (A) 200 may have been generated in a manner that will show bias in the prediction data or Bias (A) 220. For example, two distinct input data points may contain similar values across the data points with the sole exception of the value for gender. If a dissimilar prediction result is generated for both of the input data points, then the model may be generated gender biased results.

The data for bias (A) 220 that is sent to bias (A) evaluator 230. Bias (A) evaluator 230 may be any system, evaluator, score/result generator, or other entity configured to process prediction data and attempt to detect bias for a model. Examples of bias evaluators include the Generalized Entropy Index (https://doi.org/10.1145/3219819.3220046), Differential Fairness and Bias Amplification (DFBA) (https://arxiv.org/pdf/1807.08362), Wino & gender bias score (http://web.cs.ucla.edu/˜kwchang/bibliography/zhao2018gender), LOGAN (http://web.cs.ucla.edu/˜kwchang/bibliography/zhao2020logan), etc.

Bias (A) evaluator 230 may use any number of techniques to determine bias results for prediction data. In some embodiments, a bias (A) evaluator 230 will compare each prediction result value to a corresponding synthetic input data point to determine if the prediction result deviates from an expected prediction result. For example, synthetic dataset may be used to determine a statistical range of expected values for a prediction result value. The prediction result value may then be compared to the statistical range to determine the likelihood that the prediction value was generated according to some bias.

In addition to the prediction data for bias (A) 220, the bias (A) evaluator 220 may be configured to process training data for trained model 240. Because the trained model being evaluated 210 was trained using training data for trained model 240, the training data may also contain some biases that are inherent to the trained model. For example, bias (A) evaluator 230 may be configured to extract one or more statistical metrics related to the training dataset and determine if the training dataset corresponds to a bias relating to bias (A).

Bias (A) evaluator 230 utilizes the bias evaluations performed on the prediction data for bias (A) 220 and the training data for trained model 240 to generate and outputs result for bias (A) 250. In various embodiments, result for bias (A) 250 is a bias result that may be included in a set of result data 162(A)-(N). The result for bias (A) 250 may correspond to one or more metrics related to a level of bias (A) detected for trained ML model. For example, result for bias (A) 250 may contain a bias value/score describing a relative level of bias detected for the trained model being evaluated based on the prediction data for bias (A) 220 and in some embodiments, the training data for trained model 240.

FIG. 3 depicts a simplified diagram of an attribute identifier component of a bias evaluator as a service system, according to various embodiments. As depicted in FIG. 3, the attribute identifier depicted comprises several components through which data is generated. Specifically, FIG. 3 depicts attribute identifier 140 configured to intake a trained model and training dataset to produce one or more attributes.

As depicted in FIG. 3, Controller subsystem 130 may send a trained model 300 and/or a training dataset 310 to attribute identifier 140. The trained model 300 is the trained ML model for which an evaluation for bias is sought and the training dataset 310 is the dataset on which the trained model was trained.

The trained model 300 may be received at a trained model scanner 320 of attribute identifier 140. Trained model scanner 320 may be a subsystem of attribute identifier 140 that is configured to parse trained model 300 to detect one or more attributes of the trained model 300. For example, trained model scanner 320 may be configured to receive, extract, or otherwise obtain model metadata from trained model 300 in order to determine one or more attributes of an input data point that may be input to the trained model 300.

The training dataset 310 may be received at a training data scanner 330 of attribute identifier 140. Training data scanner 330 may be a subsystem of attribute identifier 140 that is configured to parse the training dataset 310 to detect one or more attributes of the trained model 300. For example, training data scanner 330 may be configured to parse the training dataset 310 to extract one or more columnar attributes of the training dataset 310 used to train the trained model 300.

The results output by trained model scanner 320 and training data scanner 330 may be aggregated by attribute aggregator 340 of attribute identifier 140. Attribute aggregator 340 may be a subsystem of attribute identifier 140 configured to compile and combined one or more attributes received from the trained model scanner 320 and the training data scanner 330 to form a combined set of one or more attributes. Attribute aggregator 340 may then output the aggregated attributes 141 to synthetic data generator 150.

With reference to the example embodiment described in above, attribute identifier 140 may receive a trained model 300 trained to intake input data points related to an employee's attributes and output a predicted salary value for the employee. The attribute identifier 140 may route the trained model 300 to trained model scanner 320 that will extract metadata from the trained model 300 corresponding to the attributes that will be input to the model. For example, based on the metadata, the trained model scanner may determine attributes of an employee's name, gender, occupation, etc. These attributes are compiled and sent to synthetic data generator 150 to generate synthetic data with the same attributes.

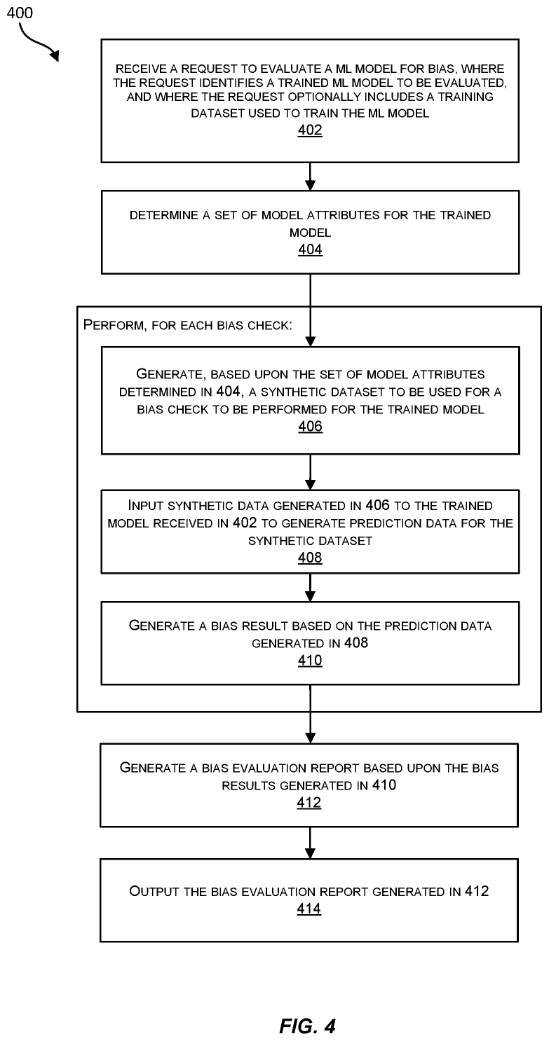

FIG. 4 depicts a simplified flow diagram illustrating an example process for generating a bias evaluation result for a trained machine learning model using a bias evaluator as a service system, according to various embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIG. 4 may be performed by BEaaSS 100.

Process 400 may be initiated at 402, where BEaaSS 100 receives a request to evaluate a ML model for bias, where the request identifies a trained ML model to be evaluated, and where the request optionally includes a training dataset used to train the ML model. The model may be received for any source that may send a trained ML model for evaluation, including, for example, a user device 110 and/or a model catalog 120. The trained model data includes a trained ML model that will be evaluated for bias. In some embodiments, the request identifies a location of the trained ML model, such as a URL from which the model may be obtained. In some embodiments, the training dataset used to train the ML model is received as part of the request, and the training dataset may be further utilized to generate synthetic data for performing one or more bias checks on the trained ML model.

At 404, a set of model attributes for the trained model is determined. The set of model attributes may be determined by a subsystem of BEaaSS 100, such as attribute identifier 140. Determination of the set of model attributes may be performed, for example, by extracting metadata from the trained model received in 402. The one or more attributes correspond to one or more categories of input that are accepted by the trained ML model for evaluation. In various embodiments, determining the one or more model attributes for the trained model comprises evaluating and/or introspecting the trained ML model. For example, metadata from the trained ML model may be identified and parsed to determine the set of model attributes. In some embodiments in which the training data is received as part of the request in 402, the training dataset is analyzed to determine the set of model attributes for the trained model.

Blocks 406-410 of FIG. 4 will occur for each bias check performed on the trained model. At 406, a synthetic dataset to be used for a bias check to be performed for the trained model is generated, based upon the set of model attributes determined in 404. The model attributes determined in 404 may be sent to a subsystem of BEaaSS 100, such as a synthetic data generator 150 to generate the synthetic dataset. The synthetic dataset may be generated according to one or more methods for generating a synthetic dataset, such as by using a GAN ML model. In various embodiments, the synthetic dataset is generated based on one or more bias types for which a bias evaluation will be performed.

At 408, synthetic data generated in 406 is input to the trained model received in 402 to generate prediction data for the synthetic dataset. For example, a bias checker such as the bias checker depicted in FIG. 2 may be used to input the synthetic data to the trained ML model to produce the prediction data. The set of predictions generated may be output as prediction data corresponding to one or more values generated by inputting one or more synthetic input data points from the synthetic dataset generated in 406 to the trained ML model.

At 410, a bias result based on the prediction data generated in 408 is generated. The bias results may be evaluated by a bias evaluator such as the bias evaluator depicted in FIG. 2. The bias result may be a value/score for a particular bias as processed and output by a particular bias checker or may be an aggregated set of bias results as processed and output by a plurality of bias checkers. In various embodiments, the bias result is generated by processing the set of predictions generating in 408 and determining one or more statistical distributions of the prediction data based on the synthetic dataset generated in 406. The bias result may thus be based on a relative deviation of a predicted value or set of predictions compared to the statistic distributions generated based on the synthetic dataset to represent a predicted level of bias inherent to predictions made by the trained ML model.

In some embodiments, a metric such as a bias score is calculate based on the bias result generated in 410. For example, a score may be calculate based on a number of input data points of an input synthetic dataset, a number of expected prediction data points of the prediction data, and the actual prediction data points of the prediction data. For example 1000 synthetic data points may be generated including a field for gender. The synthetic data may include 500 data points including a “male” gender and a 500 data point include a “female” gender. The synthetic data is then input to a ML model to generate prediction data. For example the prediction data may indicate a Boolean value of “true” or “false” and the synthetic data may be generated such that the average of the synthetic data sets only include differences in the “male” or “female” data fields. The expected of the output prediction dataset may be balanced, such that 250 of each of the “male” and “female” data points are expected to correspond to an output of “true” and 250 of each of the “male” and “female” data points are expected to correspond to an output of “false.” However, the actual output prediction data may indicate that a much larger proportion of “male” data points are “true” compared to “female” data points. This is indicative of gender bias in the ML model. The resulting score may be, for example, a ratio of the number of “female” data points that are predicted to be “true” to “male” data points that are predicted to be true. For example, if 430 “male” data points are predicted to be “true” and 31 “female” data points are predicted to be “true,” the bias score may be represented by the equation (1−(FT/MT))*100=92.8. After a bias result is generated for each of the bias checks performed, the process will proceed to 412.

At 412, output bias evaluation report is generated based on the bias results generated in 410 for each of the bias checks. The bias evaluation report may include, for example, the bias results of each particular bias check, a bias score generated based on the bias results, a depiction of a level of bias for the trained ML model, a visual representation of the level of bias detected, etc. The report may be generated for example by a report generator 170 configured to generate a bias report for review by an entity. The results may be sent, in another example, to an actions subsystem 180 to determine or cause one or more actions that may be taken based on the bias results generated.

At 414, the bias evaluation report generated in 412 is output. The bias evaluation report may be output, for example, to an entity such as the entity that originated the request in 402. For example, the report may be generated and output to an entity such as user device 110 or model catalog 120.

FIG. 5 depicts an example bias evaluation report generated by a bias evaluation as a service system, according to various embodiments. As depicted in FIG. 5, a report 500 may be presented in a readable format to an entity, such as a customer or data scientist.

As depicted in FIG. 5, a bias evaluation report may be presented in a human-readable format. The particular bias evaluation report depicted in FIG. 5 may correspond to the example embodiment described above relating to bias detection processes for a trained ML model for predicting salary values given input data points related to a traits of an employee. For example report 500 may depict the results of at least four distinct bias checks performed by four different bias checkers 161 for bias types of “Gender,” “Race,” “Religion,” and “Language.” As depicted in FIG. 5, these bias types are scored by bias checkers of score types “WINO,” “DFBA”, “<Custom_Religion>,” and “<Custom_Language>” respectively. The model being evaluated is shown as “Employee Hiring Model.”

As depicted in FIG. 5 a result of a bias check for “Gender” bias is presented along with a visual indicator of determined bias and a bias score on a scale of 1-100. Indicators are present on the visual indicator corresponding to various levels of bias determined to be present in the trained ML model. For the bias type: Gender, as depicted in FIG. 5, the result of a bias check for gender is a bias level beyond “medium,” but short of “high” is detected for gender bias with regard to the trained ML model being evaluated. This may correspond to a determination that the trained ML model being evaluated tends to predict salary values in a biased manner based on the gender specified by the input data point, though gender should have no impact on a predicted salary. As shown in FIG. 5, the bias has a score of “74” out of “100” corresponding to a relative proportion of biased prediction detected during the models prediction operations.

As used herein, a “score” may be a relative numeric representation of a level of bias detecting in a trained ML model as quantified by a bias evaluation system. For example, the score 74 out of 100 may mean that 74 out of 100 results in the prediction data generated by processing an input synthetic dataset included some determined form of bias. In other embodiments, the score may represent a relative statistical score of a bias evaluation of the model based on a sampling of similar models. The bar graphs show proximate to the score fields in FIG. 5 may show a relative level of bias as measured on a scale of bias detected in the model. For example, the depiction of the level of gender bias in FIG. 5 being beyond “medium,” but short of “high” may indicate that the gender bias detected in the model was beyond an average level of bias in similar models, but not much higher by comparison.

Also as depicted in FIG. 5 a result of a bias check for “Race” bias is presented along with a visual indicator of determined bias and a bias score on a scale of 1-100. Indicators are present on the visual indicator corresponding to various levels of bias determined to be present in the trained ML model. For the bias type: Race, as depicted in FIG. 5, the result of a bias check for race, a bias level extends beyond “medium” and is just short of “high.” This may correspond to a determination that the trained ML model being evaluated tends to predict salary values in a biased manner based on the race specified by the input data point, though race should have no impact on a predicted salary. As shown in FIG. 5, the bias has a score of “94” out of “100” corresponding to a relative proportion of biased prediction detected during the models prediction operations.

As depicted in FIG. 5 a result of a bias check for “Religion” bias is presented along with a visual indicator of determined bias and a bias score on a scale of 1-100. Indicators are present on the visual indicator corresponding to various levels of bias determined to be present in the trained ML model. For the bias type: Religion, as depicted in FIG. 5, the result of a bias check for religion is a bias level beyond “medium,” but short of “high” is detected for religious bias with regard to the trained ML model being evaluated. This may correspond to a determination that the trained ML model being evaluated tends to predict salary values in a biased manner based on the religion specified by the input data point, though religion should have no impact on a predicted salary. As shown in FIG. 5, the bias has a score of “51” out of “100” corresponding to a relative proportion of biased prediction detected during the models prediction operations.

As depicted in FIG. 5 a result of a bias check for “Language” bias is presented along with a visual indicator of determined bias and a bias score on a scale of 1-100. Indicators are present on the visual indicator corresponding to various levels of bias determined to be present in the trained ML model. For the bias type: Language, as depicted in FIG. 5, the result of a bias check for religion includes a relatively low bias level below “medium” and is detected for language bias with regard to the trained ML model being evaluated. This may correspond to a determination that the trained ML model being evaluated tends to predict salary values in a typically biased manner based on the spoken language specified by the input data point, as spoken language should have no impact on a predicted salary. As shown in FIG. 5, the bias has a score of “13” out of “100” corresponding to a relative proportion of biased prediction detected during the models prediction operations.

Report 500 also includes an overall bias evaluation visual indicator and overall combined score. The overall bias evaluation score may be an overall score generated by a component such as an overall score generator 171. In some embodiments, the overall score is generated based on the individual scores for bias types above. For example, the combined score of “58” out of “100” may be an aggregate average of bias scores for the individual bias result scores. Indicators are present on the visual indicator corresponding to aggregate average levels of bias detected in the trained ML model. As depicted in FIG. 5, the result of the overall bias check for the overall bias is a bias level beyond “medium,” but short of “high.” In various embodiments, the overall bias evaluation score may be generated as an average score of the other bias scores represented in the report 500. Any mathematical or statistical combination of the sub-scores for each bias may be utilized to form the overall score for display in the report. The corresponding bar graph of the overall bias score may indicate a relative level of overall bias for the model accounting for each bias type included in the report.

Report 500 also contains a status indicator of an action to be taken with regard to the trained ML model based on the overall score generated. For example, as depicted in FIG. 5, a field indicates that the model status of the trained ML model is “BIAS EVALUATION FAILED,” indicating that the model evaluated (“Employee Hiring Model”) contains an impermissible level of bias. The “failure” may indicate that the model should not be accepted by a catalog entity, such as a model catalog. This may correspond to a determined action to reject the trained ML model from a model catalog 120 due to the determination of at least “medium” overall bias for the trained ML model.

### Example Infrastructure-as-a-Service Implementation

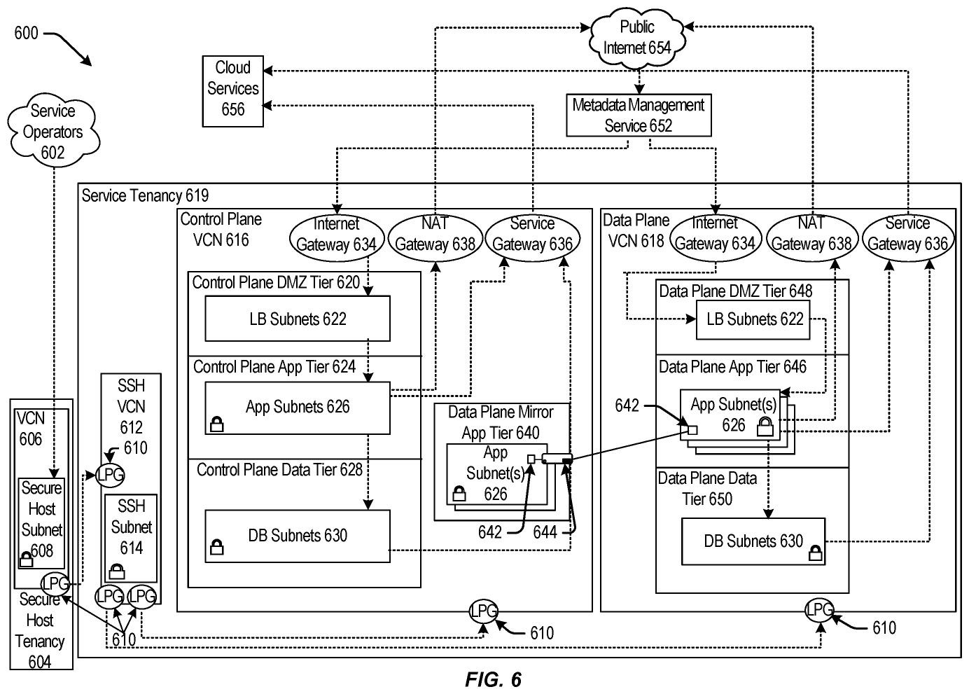

FIG. 6 depicts a bias evaluation system for determining and reporting trained ML model biases for generating predictions according to various embodiments. As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep security breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Memory that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of security, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

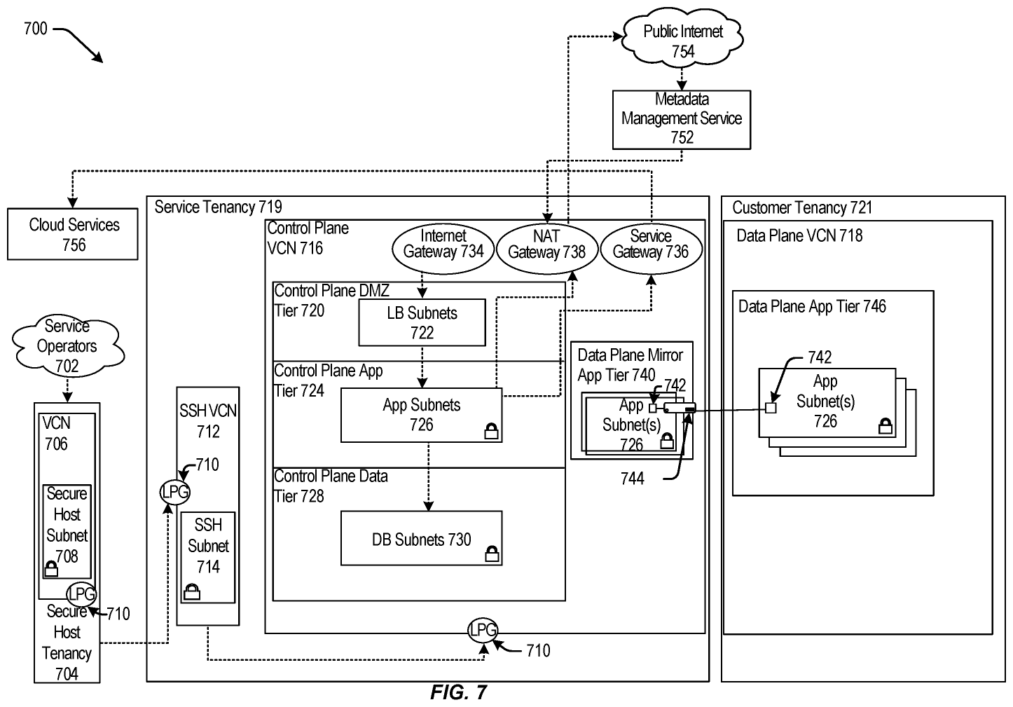

FIG. 7 is a block diagram 700 illustrating another example pattern of an IaaS architecture, according to at least one embodiment. Service operators 702 (e.g. service operators 602 of FIG. 6) can be communicatively coupled to a secure host tenancy 704 (e.g. the secure host tenancy 604 of FIG. 6) that can include a virtual cloud network (VCN) 706 (e.g. the VCN 606 of FIG. 6) and a secure host subnet 708 (e.g. the secure host subnet 608 of FIG. 6). The VCN 706 can include a local peering gateway (LPG) 710 (e.g. the LPG 610 of FIG. 6) that can be communicatively coupled to a secure shell (SSH) VCN 712 (e.g. the SSH VCN 612 of FIG. 6) via an LPG 610 contained in the SSH VCN 712. The SSH VCN 712 can include an SSH subnet 714 (e.g. the SSH subnet 614 of FIG. 6), and the SSH VCN 712 can be communicatively coupled to a control plane VCN 716 (e.g. the control plane VCN 616 of FIG. 6) via an LPG 710 contained in the control plane VCN 716. The control plane VCN 716 can be contained in a service tenancy 719 (e.g. the service tenancy 619 of FIG. 6), and the data plane VCN 718 (e.g. the data plane VCN 618 of FIG. 6) can be contained in a customer tenancy 721 that may be owned or operated by users, or customers, of the system.

The control plane VCN 716 can include a control plane DMZ tier 720 (e.g. the control plane DMZ tier 620 of FIG. 6) that can include LB subnet(s) 722 (e.g. LB subnet(s) 622 of FIG. 6), a control plane app tier 724 (e.g. the control plane app tier 624 of FIG. 6) that can include app subnet(s) 726 (e.g. app subnet(s) 626 of FIG. 6), a control plane data tier 728 (e.g. the control plane data tier 628 of FIG. 6) that can include database (DB) subnet(s) 730 (e.g. similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g. the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g. the service gateway of FIG. 6) and a network address translation (NAT) gateway 738 (e.g. the NAT gateway 638 of FIG. 6). The control plane VCN 716 can include the service gateway 736 and the NAT gateway 738.

The control plane VCN 716 can include a data plane mirror app tier 740 (e.g. the data plane mirror app tier 640 of FIG. 6) that can include app subnet(s) 726. The app subnet(s) 726 contained in the data plane mirror app tier 740 can include a virtual network interface controller (VNIC) 742 (e.g. the VNIC of 642) that can execute a compute instance 744 (e.g. similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g. the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g. the metadata management service 652 of FIG. 6) that can be communicatively coupled to public Internet 754 (e.g. public Internet 654 of FIG. 6). Public Internet 754 can be communicatively coupled to the NAT gateway 738 contained in the control plane VCN 716. The service gateway 736 contained in the control plane VCN 716 can be communicatively couple to cloud services 756 (e.g. cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718, but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 8,” may be located in Region 1 and in “Region 2.” If a call to Deployment 8 is made by the service gateway 736 contained in the control plane VCN 716 located in Region 1, the call may be transmitted to Deployment 8 in Region 1. In this example, the control plane VCN 716, or Deployment 8 in Region 1, may not be communicatively coupled to, or otherwise in communication with, Deployment 8 in Region 2.

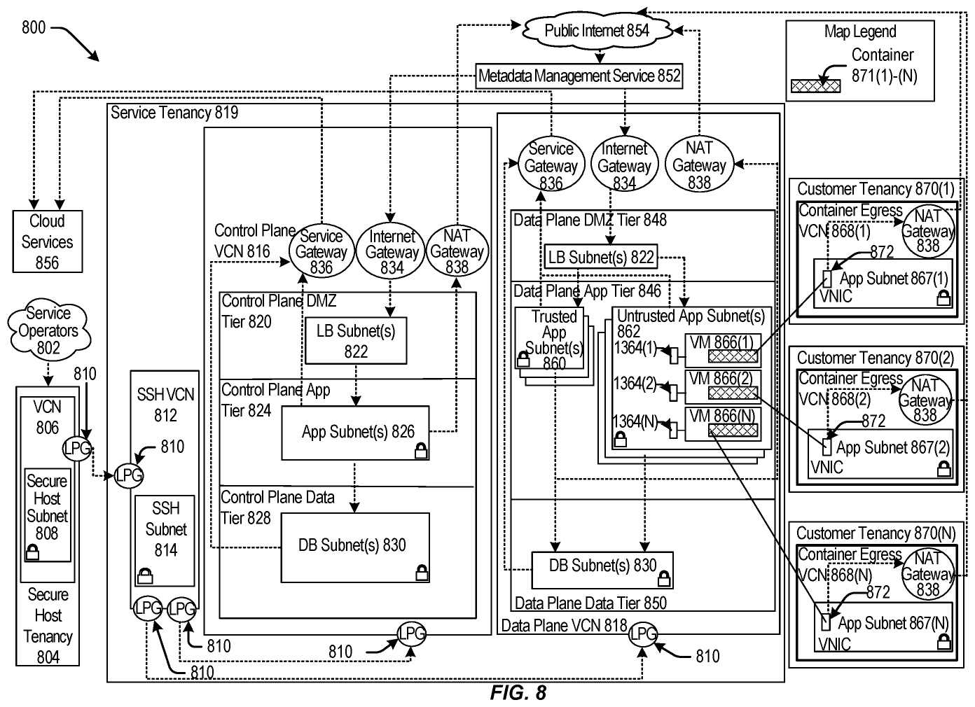

FIG. 8 is a block diagram 800 illustrating another example pattern of an IaaS architecture, according to at least one embodiment. Service operators 802 (e.g. service operators 602 of FIG. 6) can be communicatively coupled to a secure host tenancy 804 (e.g. the secure host tenancy 604 of FIG. 6) that can include a virtual cloud network (VCN) 806 (e.g. the VCN 606 of FIG. 6) and a secure host subnet 808 (e.g. the secure host subnet 608 of FIG. 6). The VCN 806 can include an LPG 810 (e.g. the LPG 610 of FIG. 6) that can be communicatively coupled to an SSH VCN 812 (e.g. the SSH VCN 612 of FIG. 6) via an LPG 810 contained in the SSH VCN 812. The SSH VCN 812 can include an SSH subnet 814 (e.g. the SSH subnet 614 of FIG. 6), and the SSH VCN 812 can be communicatively coupled to a control plane VCN 816 (e.g. the control plane VCN 616 of FIG. 6) via an LPG 810 contained in the control plane VCN 816 and to a data plane VCN 818 (e.g. the data plane 618 of FIG. 6) via an LPG 810 contained in the data plane VCN 818. The control plane VCN 816 and the data plane VCN 818 can be contained in a service tenancy 819 (e.g. the service tenancy 619 of FIG. 6).

The control plane VCN 816 can include a control plane DMZ tier 820 (e.g. the control plane DMZ tier 620 of FIG. 6) that can include load balancer (LB) subnet(s) 822 (e.g. LB subnet(s) 622 of FIG. 6), a control plane app tier 824 (e.g. the control plane app tier 624 of FIG. 6) that can include app subnet(s) 826 (e.g. similar to app subnet(s) 626 of FIG. 6), a control plane data tier 828 (e.g. the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g. the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 6) and a network address translation (NAT) gateway 838 (e.g. the NAT gateway 638 of FIG. 6). The control plane VCN 816 can include the service gateway 836 and the NAT gateway 838.

The data plane VCN 818 can include a data plane app tier 846 (e.g. the data plane app tier 646 of FIG. 6), a data plane DMZ tier 848 (e.g. the data plane DMZ tier 648 of FIG. 6), and a data plane data tier 850 (e.g. the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g. public Internet 654 of FIG. 6).

The Internet gateway 834 contained in the control plane VCN 816 and contained in the data plane VCN 818 can be communicatively coupled to a metadata management service 852 (e.g. the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

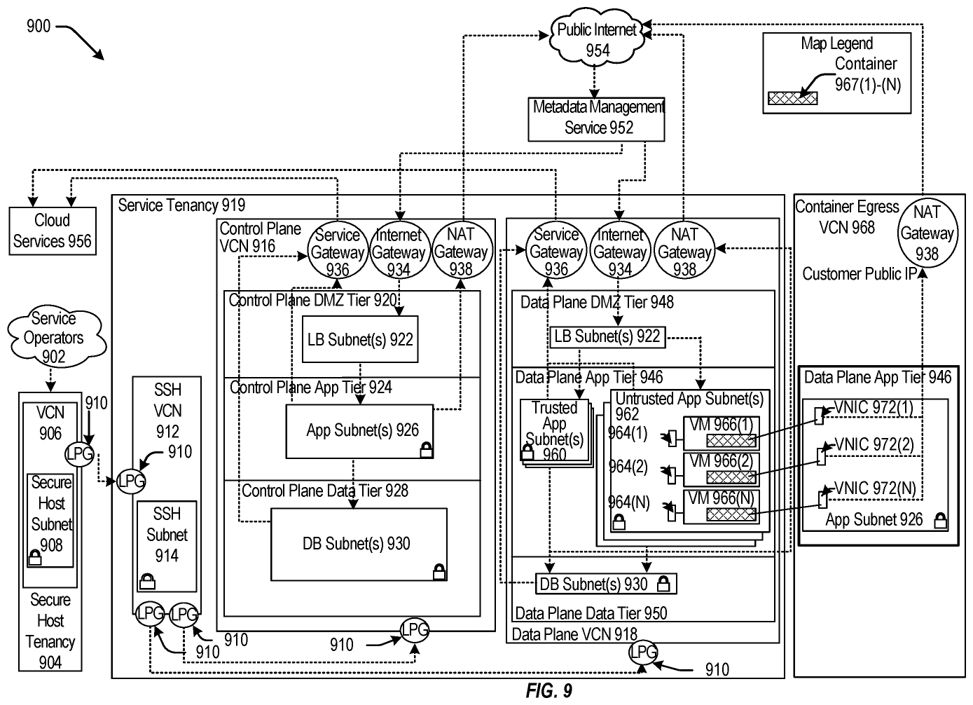

FIG. 9 is a block diagram 900 illustrating another example pattern of an IaaS architecture, according to at least one embodiment. Service operators 902 (e.g. service operators 602 of FIG. 6) can be communicatively coupled to a secure host tenancy 904 (e.g. the secure host tenancy 604 of FIG. 6) that can include a virtual cloud network (VCN) 906 (e.g. the VCN 606 of FIG. 6) and a secure host subnet 908 (e.g. the secure host subnet 608 of FIG. 6). The VCN 906 can include an LPG 910 (e.g. the LPG 610 of FIG. 6) that can be communicatively coupled to an SSH VCN 912 (e.g. the SSH VCN 612 of FIG. 6) via an LPG 910 contained in the SSH VCN 912. The SSH VCN 912 can include an SSH subnet 914 (e.g. the SSH subnet 614 of FIG. 6), and the SSH VCN 912 can be communicatively coupled to a control plane VCN 916 (e.g. the control plane VCN 616 of FIG. 6) via an LPG 910 contained in the control plane VCN 916 and to a data plane VCN 918 (e.g. the data plane 618 of FIG. 6) via an LPG 910 contained in the data plane VCN 918. The control plane VCN 916 and the data plane VCN 918 can be contained in a service tenancy 919 (e.g. the service tenancy 619 of FIG. 6).

The control plane VCN 916 can include a control plane DMZ tier 920 (e.g. the control plane DMZ tier 620 of FIG. 6) that can include LB subnet(s) 922 (e.g. LB subnet(s) 622 of FIG. 6), a control plane app tier 924 (e.g. the control plane app tier 624 of FIG. 6) that can include app subnet(s) 926 (e.g. app subnet(s) 626 of FIG. 6), a control plane data tier 928 (e.g. the control plane data tier 628 of FIG. 6) that can include DB subnet(s) 930 (e.g. DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g. the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g. the service gateway of FIG. 6) and a network address translation (NAT) gateway 938 (e.g. the NAT gateway 638 of FIG. 6). The control plane VCN 916 can include the service gateway 936 and the NAT gateway 938.

The data plane VCN 918 can include a data plane app tier 946 (e.g. the data plane app tier 646 of FIG. 6), a data plane DMZ tier 948 (e.g. the data plane DMZ tier 648 of FIG. 6), and a data plane data tier 950 (e.g. the data plane data tier 650 of FIG. 6). The data plane DMZ tier 948 can include LB subnet(s) 922 that can be communicatively coupled to trusted app subnet(s) 960 (e.g. trusted app subnet(s) 860 of FIG. 8) and untrusted app subnet(s) 962 (e.g. untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g. public Internet 654 of FIG. 6).

The Internet gateway 934 contained in the control plane VCN 916 and contained in the data plane VCN 918 can be communicatively coupled to a metadata management service 952 (e.g. the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

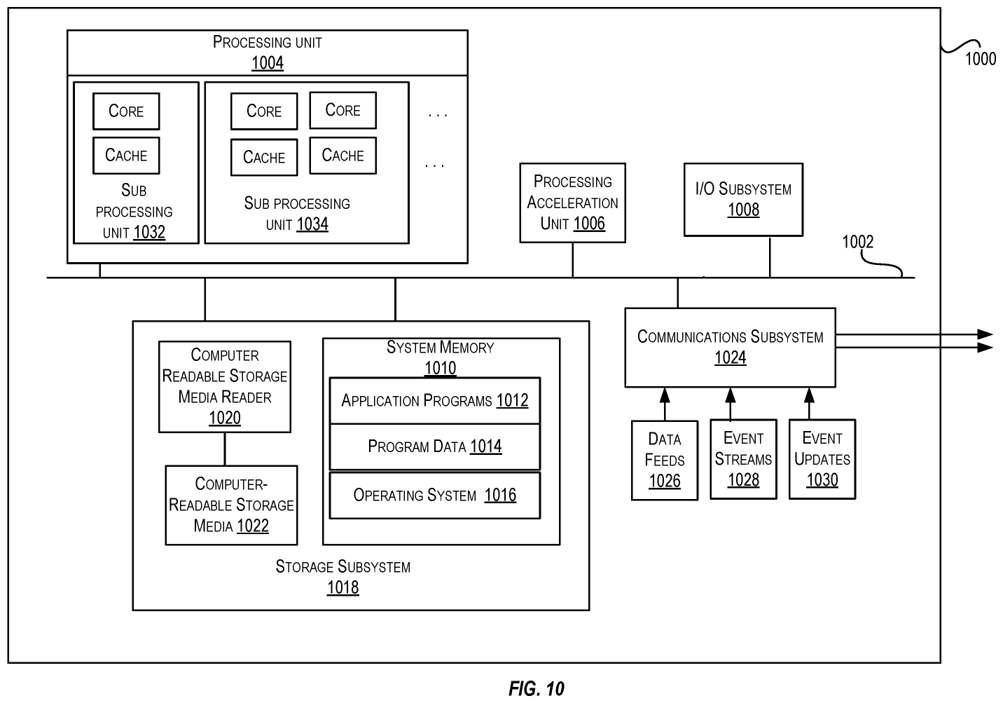

FIG. 10 illustrates an example computer system 1000, that may be used to implement various embodiments . The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like. I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that comprises software elements, shown as being currently located within a system memory 1010. System memory 1010 may store program instructions that are loadable and executable on processing unit 1004, as well as data generated during the execution of these programs.

Depending on the configuration and type of computer system 1000, system memory 1010 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1004. In some implementations, system memory 1010 may include multiple different types of memory, such as static random access memory (SRAM) or dynamic random access memory (DRAM). In some implementations, a basic input/output system (BIOS), containing the basic routines that help to transfer information between elements within computer system 1000, such as during start-up, may typically be stored in the ROM. By way of example, and not limitation, system memory 1010 also illustrates application programs 1012, which may include client applications, Web browsers, mid-tier applications, relational database management systems (RDBMS), etc., program data 1014, and an operating system 1016. By way of example, operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 6 OS, and Palm® OS operating systems.

Storage subsystem 1018 may also provide a tangible computer-readable storage medium for storing the basic programming and data constructs that provide the functionality of some embodiments. Software (programs, code modules, instructions) that when executed by a processor provide the functionality described above may be stored in storage subsystem 1018. These software modules or instructions may be executed by processing unit 1004. Storage subsystem 1018 may also provide a repository for storing data used in accordance with the present disclosure.

Storage subsystem 1018 may also include a computer-readable storage media reader 1020 that can further be connected to computer-readable storage media 1022. Together and, optionally, in combination with system memory 1010, computer-readable storage media 1022 may comprehensively represent remote, local, fixed, and/or removable storage devices plus storage media for temporarily and/or more permanently containing, storing, transmitting, and retrieving computer-readable information.

Computer-readable storage media 1022 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1000.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the claims is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the disclosed embodiments. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the claimed embodiments.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising, ” “having, ” “including, ” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate certain embodiments and does not pose a limitation on the scope of the disclosed techniques. No language in the specification should be construed as indicating any non-claimed element as essential to the practice of the claimed embodiments.

Disjunctive language such as the phrase “at least one of X, Y, or Z, ” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments are described herein, including the best mode known for carrying out the various embodiments. Variations of those preferred embodiments may become apparent to those of ordinary skill in the art upon reading the foregoing description. Those of ordinary skill should be able to employ such variations as appropriate and the described embodiments may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, novel aspects are described with reference to specific embodiments thereof, but those skilled in the art will recognize that the disclosure is not limited thereto. Various features and aspects of the above-described embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
for a trained model to be evaluated, determining, by a computing system, a set of model attributes for the trained model;
generating, by the computing system and based upon the set of model attributes, a first synthetic dataset to be used for a first bias check to be performed for the trained model, the first bias check configured to evaluate the trained model with respect to a first bias type, the first synthetic dataset comprising a plurality of data points;
generating, using the trained model, first prediction data for the first synthetic dataset, the first prediction data comprising a first plurality of predicted values generated by the trained model for the plurality of data points in the first synthetic dataset;
generating, by the computing system, a first bias result for the first bias type based upon the first prediction data; and
generating, by the computing system, a bias evaluation report for the trained model, wherein the bias evaluation report comprises information indicative of the first bias result.

2. The computer-implemented method of claim 1, wherein the first bias result comprises one or more bias values generated based on the first prediction data.

3. The computer-implemented method of claim 2, wherein the bias evaluation report comprises the first bias result and the one or more bias values, and the method further comprising outputting the bias evaluation report.

4. The computer-implemented method of claim 2, further comprising:
comparing at least a bias value of the one or more bias values to a bias to a bias threshold; and
determining, based on the comparison, whether to accept or reject the trained model from inclusion in a group of trained models.

5. The computer-implemented method of claim 1, further comprising:
generating, by the computing system and based upon the set of model attributes, a second synthetic dataset to be used for a second bias check to be performed for the trained model, the second bias check configured to evaluate the trained model with respect to a second bias type, the second synthetic dataset comprising a plurality of data points;
generating, using the trained model, a second set of predictions for the second synthetic dataset; and
generating, by the computing system, a second bias result for the first bias type based upon the first prediction data.

6. The computer-implemented method of claim 5, further comprising:
generating, by the computing system, a bias score based on the first bias result and the second bias result; and
determining, based on the generated bias score, whether to accept or reject the trained model from inclusion in a group of trained models.

7. The computer-implemented method of claim 1, wherein determining the set of model attributes comprises processing the trained model to determine at least one model attribute in the set of model attributes.

8. The computer-implemented method of claim 1, wherein determining the set of model attributes comprises determining at least one model attribute in the set of model attributes based upon analysis of training data used for training and generating the trained model.

9. The computer-implemented method of claim 1, further comprising:
determining training data used for training and generating the trained model; and
generating, by the computing system, a second bias result for the first bias type based on the training data, wherein generating the first bias result is further based on the generated second bias result.

10. The computer-implemented method of claim 1, wherein generating the first synthetic dataset comprises generating, by the computing system and based on the set of model attributes for the trained model and using a generative neural network machine learning model, the first synthetic dataset.

11. The method of claim 1, wherein:
the trained model is a neural network; and
the prediction data further comprises at least one value generated by an output layer of the neural network.

12. A system comprising:
one or more computing devices;
one or more processors; and
a memory including instructions that, when executed by the one or more processors, cause the system to perform processing comprising:
for a trained model to be evaluated, determining, by a computing system, a set of model attributes for the trained model;
generating, by the computing system and based upon the set of model attributes, a first synthetic dataset to be used for a first bias check to be performed for the trained model, the first bias check configured to evaluate the trained model with respect to a first bias type, the first synthetic dataset comprising a plurality of data points;
generating, using the trained model, first prediction data for the first synthetic dataset, the first prediction data comprising a first plurality of predicted values generated by the trained model for the plurality of data points in the first synthetic dataset;
generating, by the computing system, a first bias result for the first bias type based upon the first prediction data; and
generating, by the computing system, a bias evaluation report for the trained model, wherein the bias evaluation report comprises information indicative of the first bias result.

13. The system of claim 12, wherein the processing further comprises:
generating, based upon the set of model attributes, a second synthetic dataset to be used for a second bias check to be performed for the trained model, the second bias check configured to evaluate the trained model with respect to a second bias type, the second synthetic dataset comprising a plurality of data points; generating, using the trained model, a second set of predictions for the second synthetic dataset; and
generating a second bias result for the first bias type based upon the first prediction data.

14. The system of claim 13, wherein the processing further comprises:
generating a bias score based on the first bias result and the second bias result; and
determining, based on the generated bias score, whether to accept or reject the trained model from inclusion in a group of trained models.

15. The system of claim 12, wherein determining the set of model attributes comprises processing the trained model to determine at least one model attribute in the set of model attributes.

16. The system of claim 12, wherein determining the set of model attributes comprises determining at least one model attribute in the set of model attributes based upon analysis of training data used for training and generating the trained model.

17. The system of claim 12, wherein the processing further comprises:
determining training data used for training and generating the trained model; and
generating a second bias result for the first bias type based on the training data, wherein generating the first bias result is further based on the generated second bias result.

18. The system of claim 12, wherein generating the first synthetic dataset comprises generating, by the computing system and based on the set of model attributes for the trained model and using a generative neural network machine learning model, the first synthetic dataset.

19. A non-transitory computer-readable medium storing a plurality of instructions executable by one or more processors, and when executed by the one or more processors cause the one or more processors to perform processing comprising:
for a trained model to be evaluated, determining, by a computing system, a set of model attributes for the trained model;
generating, by the computing system and based upon the set of model attributes, a first synthetic dataset to be used for a first bias check to be performed for the trained model, the first bias check configured to evaluate the trained model with respect to a first bias type, the first synthetic dataset comprising a plurality of data points;
generating, using the trained model, first prediction data for the first synthetic dataset, the first prediction data comprising a first plurality of predicted values generated by the trained model for the plurality of data points in the first synthetic dataset;
generating, by the computing system, a first bias result for the first bias type based upon the first prediction data; and
generating, by the computing system, a bias evaluation report for the trained model, wherein the bias evaluation report comprises information indicative of the first bias result.

20. The non-transitory computer-readable medium of claim 18, wherein the first bias result comprises one or more bias values generated based on the first prediction data.
